(19) United States
(12) Patent Application Publication
(10) Pub. No.: US 2005/0087063 A1
(43) Pub. Date: Apr. 28, 2005

(54) Bi-directional switch apparatus with electric guitar applications

(76) Inventor: Alasdair James Bryce, Bradford (GB)

Correspondence Address: Mr. Alasdair J. Bryce, 74 Branksome Drive, Bradford, West Yorkshire, BD18 4BE, GB

(21) Appl. No.: 10/912,693

(22) Filed: Aug. 6, 2004

(30) Foreign Application Priority Data
Oct. 28, 2003 (GB) GB0325103

(51) Int. Cl. G10H 3/14; G10H 1/18; G10H 3/12

(52) U.S. Cl. 84/742

(57) ABSTRACT

A selector switch for musical instruments, such as electric guitars is provided having a single, manually operated toggle member adapted to perform greater functionality. A selector switch is disclosed which indexes longitudinally for the electrical connection of pickup(s) for resultant amplification but will additionally provide further associated connectivity by means of a transverse indexing motion thus availing expanded switching function from a single switch apparatus. This inventive step is referred to as a compound selector switch.

### CROSS-REFERENCE TO OTHER RELATED APPLICATIONS

This application relates to and claims priority from GB Patent Application Number GB 0325103, filed on Oct. 28, 2003, disclosure of which is incorporated herein by reference.

### BACKGROUND OF THE INVENTION

1. Field of the Invention

This invention relates to pickup switching apparatus for electric guitars, of any type, having more than one pickup. Electric guitar players prefer to selectively use: pickup(s); pickup configuration; additional electrical circuitry and types of amplification in different combinations so as to produce those tonal qualities suitable to the varying playing styles which they favour. Changing between such tonalities may be a frequent requirement and can involve multiple switch operation.

On a two pickup guitar, a conventional three-position toggle switch is the primary means of selection and will connect either pickup alone at it's extreme index positions, or both pickups in parallel in it's central index position for resultant amplification. This switch element is now a long-established feature of electric guitars and is illustrated in U.S. Pat. No. 2,714,326 of August, 1955 to McCarty as switch ‘9’.

On a three pickup guitar, a conventional five-position switch is the primary means of selection and will connect bridge pickup alone, bridge and middle pickups in parallel, middle pickup alone, middle and neck pickups in parallel, and neck pickup alone for resultant amplification in respective index positions. This switch element is now also a long-established feature of electric guitars and evolved from the switch illustrated as ‘10’ in U.S. Pat. No. 2,741,146 of April, 1956 to Fender.

2. Description of the Related Art

Other types of pickup selector switches have been known in the prior art, for example a rocker switch disclosed in U.S. Pat. No. 4,305,320 of December, 1981 to Peavey which was intended for operation by the palm of the hand. Guitarists may, conservatively, consider this to be an unfamiliar action.

Multi-indexing rotary controls have also been used for pickup selection but are generally regarded as inferior in this application in that they offer poor visual representation of their settings and in that their operation is less intuitive than the aforementioned three-position or five-position selector switches.

Guitars which offer a wider range of electrical configuration options may incorporate a variety of switches and additional circuitry. Typically, these may include: three or five-position selector switches; separate toggle switch(es); push-button switch(es); slider switch(es); multi-indexing rotary switches; or, push/pull or push/push switching enacted from associated potentiometer apparatus, or combinations thereof. There are many examples of such designs in the prior art, of which the following two are identified herein to demonstrate an overview of progressive practice.

As a first example, GB Patent No. 2207542 of February, 1989 to Mullen, discloses a means of selectively configuring three single-coil pickups by means of three separate toggle switches together with a three-position rotary switch. This system does demonstrate the advantageous feature of connecting combinations of single-coil pickups in a series connection among its diversity of settings and switches.

As a second example, it is known that various guitars have been designed to offer a combination of the tonalities generally associated with formative manufacturers Gibson and Fender. Such guitars generally employ dual-coil bridge pickup, single-coil middle pickup, and dual-coil neck pickup. In this format, dual-coil bridge and neck pickups are selectively used to approximate the ‘Gibson’ tonalities, whereas, a single coil of each of the dual-coil bridge and neck pickups are selectively used with the single-coil middle pickup to approximate the ‘Fender’ tonalities. Such a system is disclosed in U.S. Pat. No. 5,136,918 of August, 1992 to Riboloff, where the function of a five-position selector switch varies dependant upon a secondary switch element so as to provide ‘Gibson’ and ‘Fender’ modes of operation.

Although offering expanded functionality, such switching arrangements, as illustrated in the foregoing examples, may be confusing and slow to operate in that it is necessary to recognise the settings on more than one switch and then to change the settings on more than one switch whilst maintaining concentration on the musical performance. Such arrangements may also exhibit an unfamiliar progression of settings upon indexing the selector switch, or may introduce an excessive level of diversity where the differences between some settings are practically indiscernible. Ultimately, they may lack a clarity of function which would be essential for any widespread acceptance.

Onboard electronic switching systems are also known in the prior art, for example, U.S. Pat. No. 4,711,149 of December, 1987 to Starr which, although offering diverse functionality, may be beyond the expectations of most guitarists who may also feel that the character of their instruments would be impaired by installing such a device.

Ultimately, the use of three-position and five-position pickup selector switches has become part of the skill of the guitar player and is familiar to those players.

### BRIEF SUMMARY OF THE INVENTION

It is the object of this invention: to provide expanded selector switching functionality from a single switch member thus providing a simplified, comprehensive and rapidly operable control for the guitarist; to provide selector switching which is familiar to the guitarist and can be used intuitively by virtue of it's visual and tactile qualities; to provide selector switching which may be integrated harmoniously within a range of different guitar models, and; to provide selector switching which may be manufactured and installed economically and be compatible with various types of pickup and associated equipment, in order that it may find widespread application.

To achieve the foregoing objects, the present invention provides for typically three-position and five-position pickup selector switches whereupon the toggle members index longitudinally in the conventional manner but also index transversely so as to avail parallel index positions whereupon additional electrical switching is enacted so as to provide enhanced functionality. This inventive concept will be hereafter referred to as a compound selector switch.

It will be shown that such compound selector switches may exist in a number of embodiments and can be used in a wide range of applications. In all instances, however, compound selector switches provide guitarists with a single control element which may operatively replace the combinations of discrete switches used on conventional guitars and may afford concurrent control of their functionality.

### BRIEF DESCRIPTION OF THE SEVERAL VIEWS OF THE DRAWING

FIG. 1 is a perspective view of a generic two pickup electric guitar showing the embodiment ‘A’ compound selector switch mounted therein;

FIG. 2 is an enlarged detail view taken from FIG. 1 illustrating the indexing array;

FIG. 3 is a perspective view of the embodiment ‘A’ compound selector switch shown in isolation from the guitar;

FIG. 4 is an exploded view of the embodiment ‘A’ compound selector switch which illustrates all the component parts;

FIG. 5 is a partially exploded view of the embodiment ‘A’ compound selector switch which illustrates an internal relationship of the component parts;

FIG. 6 is a sectional view taken on line 1-1 of the embodiment ‘A’ compound selector switch;

FIG. 7 is a sectional view taken on line 2-2 of the embodiment ‘A’ compound selector switch;

FIG. 8 is a schematic circuit diagram demonstrating a first application of the embodiment ‘A’ compound selector switch;

FIG. 9 is a schematic circuit diagram demonstrating a second application of the embodiment ‘A’ compound selector switch;

FIG. 10 is a schematic circuit diagram demonstrating a third application of the embodiment ‘A’ compound selector switch;

FIG. 11 is a schematic circuit diagram demonstrating a fourth application of the embodiment ‘A’ compound selector switch;

FIG. 12 is a perspective view of a generic three pickup electric guitar showing the embodiment ‘B’ compound selector switch mounted therein;

FIG. 13 is a plan view upon the embodiment ‘B’ compound selector switch illustrating a first example of the indexing array;

FIG. 14 is a plan view upon the embodiment ‘B’ compound selector switch illustrating a second example of the indexing array;

FIG. 15 is a plan view upon the embodiment ‘B’ compound selector switch illustrating a third example of the indexing array;

FIG. 16 is a perspective view of the embodiment ‘B’ compound selector switch shown in isolation from the guitar;

FIG. 17 is an exploded view of the embodiment ‘B’ compound selector switch which illustrates all the component parts;

FIG. 18 is a perspective view showing an alternative orientation of one of the components of the embodiment ‘B’ compound selector switch;

FIG. 19 is a sectional view taken on line 3-3 of the embodiment ‘B’ compound selector switch;

FIG. 20 is a perspective view of the embodiment ‘B’ compound selector switch where various components are omitted for clarity;

FIG. 21 is a sectional view taken on line 4-4 of the embodiment ‘B’ compound selector switch shown as in position 72;

FIG. 22 is a sectional view taken on line 4-4 of the embodiment ‘B’ compound selector switch shown as in position 67;

FIG. 23 is a schematic circuit diagram demonstrating a first application of the embodiment ‘B’ compound selector switch;

FIG. 24 is a schematic circuit diagram demonstrating a second application of the embodiment ‘B’ compound selector switch.

### DETAIL DESCRIPTION OF THE INVENTION

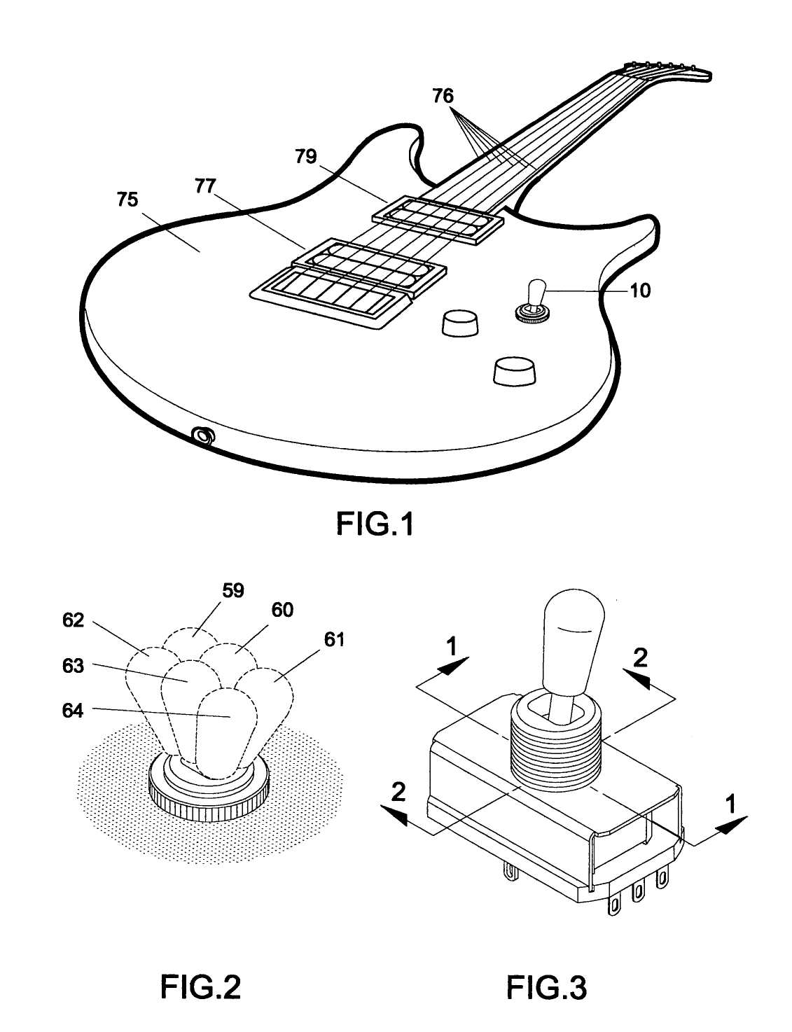

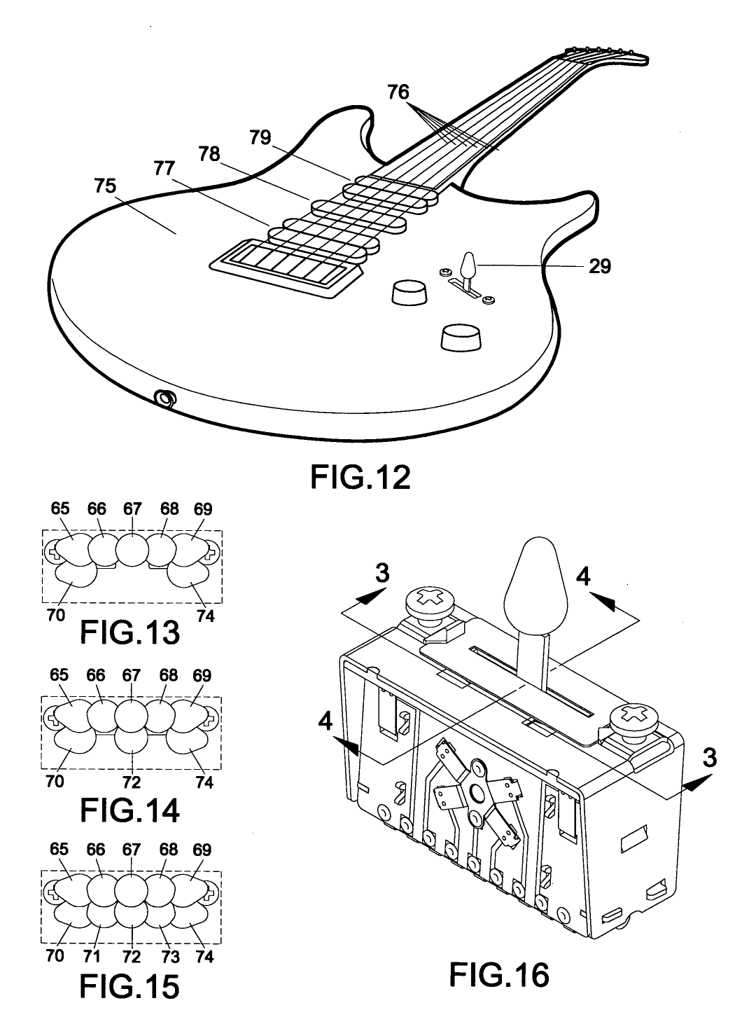

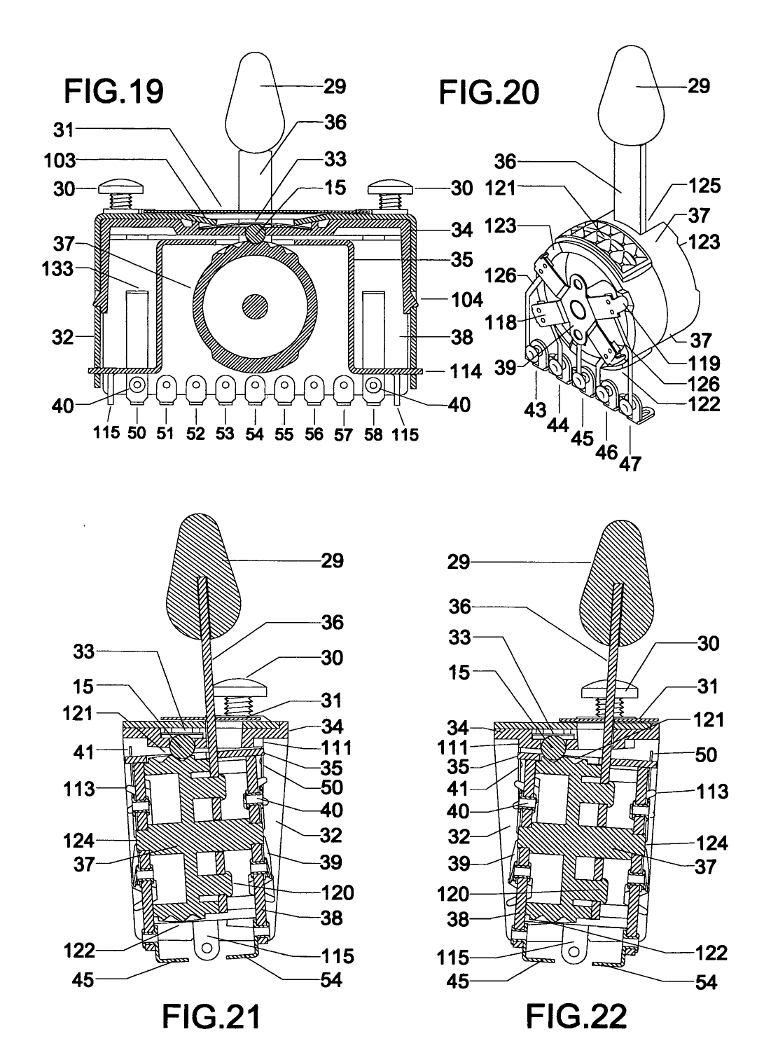

Compound selector switches may exist in a variety of forms and two main embodiments are described herein. Embodiment ‘A’ manifests a compound version of a typical three-position selector switch and is illustrated and described in FIG. 1 through FIG. 11. Embodiment ‘B’ manifests a compound version of a typical five-position selector switch and is illustrated and described in FIG. 12 through FIG. 24.

In respect of embodiment ‘A’, FIG. 1 illustrates a stringed instrument of the electric guitar type wherein a plurality of strings 76 are anchored and tensioned in such a way that their vibration interacts with bridge pickup 77 and neck pickup 79 which are also mounted on the guitar. Mounted internally within the guitar but with outwardly protruding toggle member 10, the compound selector switch is positioned so as to be manually operable by the player.

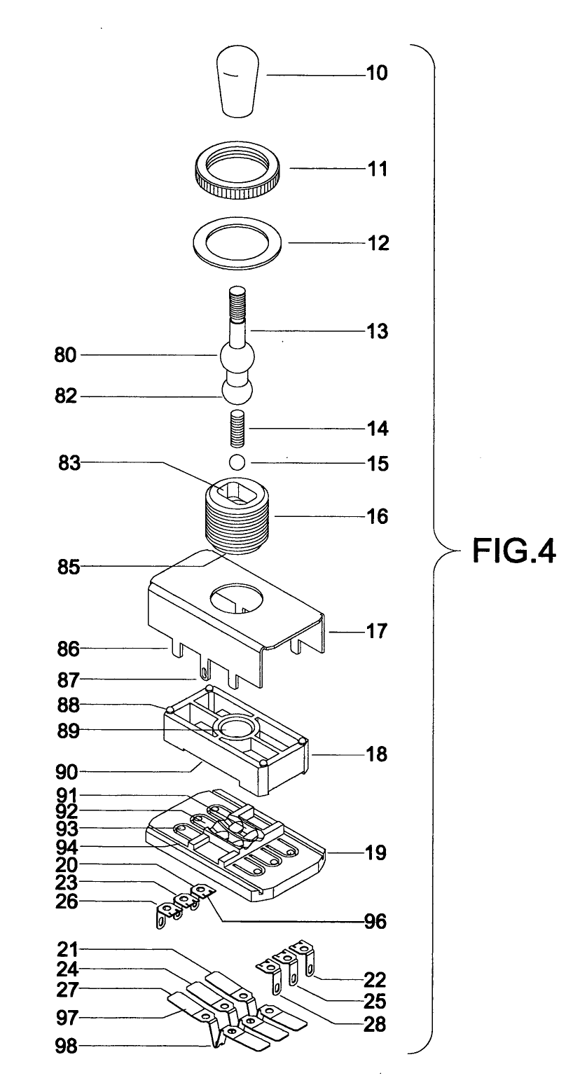

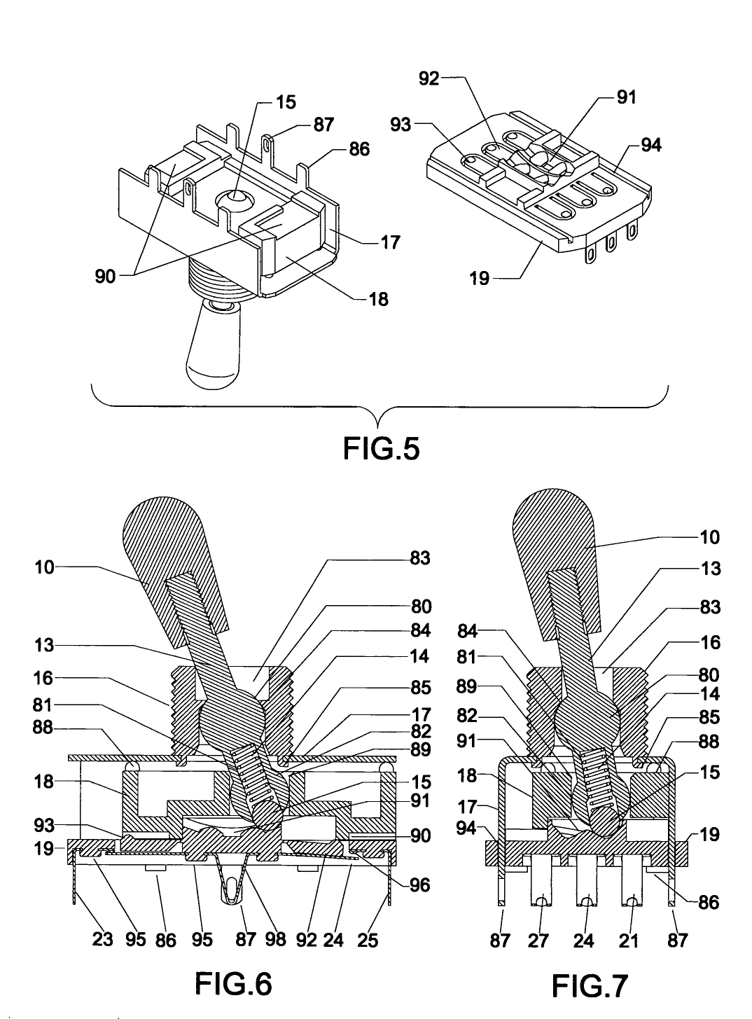

FIG. 2 shows an enlarged view of said outwardly protruding toggle member 10 and illustrates the various index positions available in operation. Note that toggle member 10 is orientated in index position 60 in FIG. 1, FIG. 3 and FIG. 5. FIG. 3 shows a view of the assembled embodiment ‘A’ compound selector switch, whereas FIG. 4 illustrates all of the component parts in exploded form.

With reference to FIG. 4, Toggle member 10 is a plastic moulded cap which attaches by screw-thread means to lever 13 which is a machined steel component. Threaded collar 16 is a machined steel component which attaches, by swaging flange 85 to casing 17 which is a press-formed steel component. Actuator moulding 18 and detent moulding 19 are both injection moulded plastic components of a suitably resilient material such as polypropylene. Electrical contacts 20 through 28 are of a material customarily used in such applications such as Phosphor Bronze and may be treated with surface platings.

The assembly is completed by locating tabs 86 of casing 17 into corresponding slots & apertures 94 of detent moulding 19 and folding them inwards to secure. Tabs 87 of casing 17 are not folded and thus act as ground terminations for subsequent wiring. Fitting of the completed compound selector switch requires that threaded collar 16 should be located into a corresponding hole in guitar body 75 and is then secured with ring nut 11 above washer 12 as illustrated in FIG. 1 and FIG. 2.

Additional reference is now drawn to FIG. 5, FIG. 6 and FIG. 7 which show the relative arrangement of elements of the compound selector switch.

Lever 13 is adapted with ball form 80 which engages into cavity 84 of threaded collar 16 thus defining a relative pivotal freedom of movement. This pivotal movement is limited by aperture 83 of threaded collar 16 upon which lever 13 engages at the extremes of it's travel. Lever 13 is further adapted with a concentric hole 81 which houses compression spring 14 and steel ball 15. As lever 13 is manually displaced, steel ball 15 engages into detent form 91 of detent moulding 19 so as to define the specific index positions 59 through 64. Lever 13 is further adapted with ball form 82 which engages into a hole 89 of actuator moulding 18. Actuator moulding 18 is enclosed within the assembly by casing 17 and detent moulding 19, and reacts to the displacement of lever 13 in a longitudinal and lateral sliding motion. Actuator moulding 18 has four bosses 88 which locate internally upon casing 17 and a profiled underside 90 which engages on the surface of detent moulding 19. Detent moulding 19 is adapted with six flexible tongues 92 which are outwardly displaceable by means of raised bosses 93 which engage selectively with the underside profiling 90 of actuator moulding 18.

Detent moulding 19 is adapted to it's outer face with a series of protrusions 95 to which contacts 20 through 28 are attached by means of heat peening. Outer contacts 20, 22, 23, 25, 26 and 28 are adapted with raised contact points 96 to their inner ends, whereas the outer ends are adapted for solder termination. Centre contacts 21, 24 and 27 are adapted with upwardly biased ends 97 such that, when assembled, they apply a positive connection force to the raised contact points 96 of the outer contacts. Centre contacts 21, 24 and 27 are further adapted with a ‘V’ form 98 to accommodate solder termination. Where the underside profile 90 of actuator moulding 18 displaces tongues 92 by means of raised bosses 93, electrical contact between centre and outer contacts is broken.

Contact groups 20+21+22, 23+24+25, and 26+27+28 effectively form three single-pole, double-throw switches whose electrical function, relative to the indexing action of lever 13, is governed by the underside profiling 90 of actuator moulding 18.

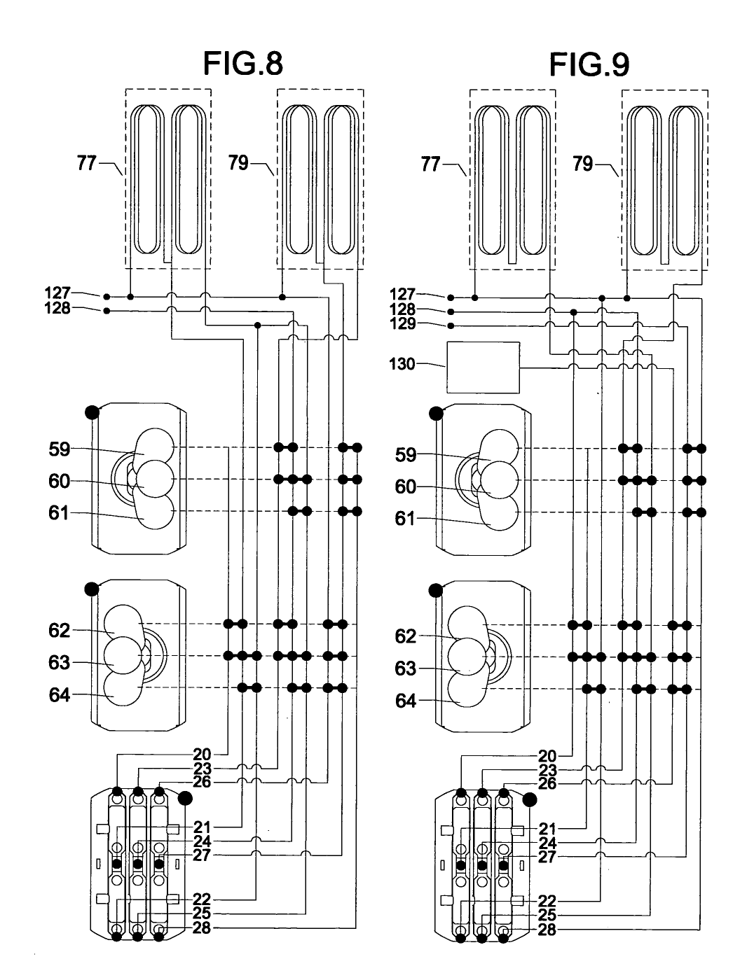

FIG. 8 through FIG. 11 illustrate the preferred electrical function, relative to each index position, of the embodiment ‘A’ compound selector switch and also demonstrate a variety of functions.

FIG. 8 illustrates how the outputs of pickups 77 and 79 are selectively connected to output pairing 127+128 to provide the customary pickup settings in positions 59 through 61. These settings are also exhibited in positions 62 through 64 at which the ‘inner’ coils of pickups 77 and 79 are disabled via the connections at 21+22 and 26+27 respectively. This effectively performs an integrated ‘coil-tap’ function normally effected from discrete switching.

FIG. 9 illustrates how the outputs of pickups 77 and 79 are selectively connected to output pairing 127+128 to provide the customary pickup settings in positions 59 through 61. Positions 62 through 64 connect the output of piezo pickup source 130 to output pairing 127+129 via the connections at 26+27. Positions 62 and 64 connect neck pickup 79 and bridge pickup 77 to output pairing 127+128 respectively. Position 63 connects output 128 to ground at 127 via the connection path 20+22. This effectively provides an integrated ‘magnetic/magnetic+piezo/piezo’ function normally effected from discrete switching.

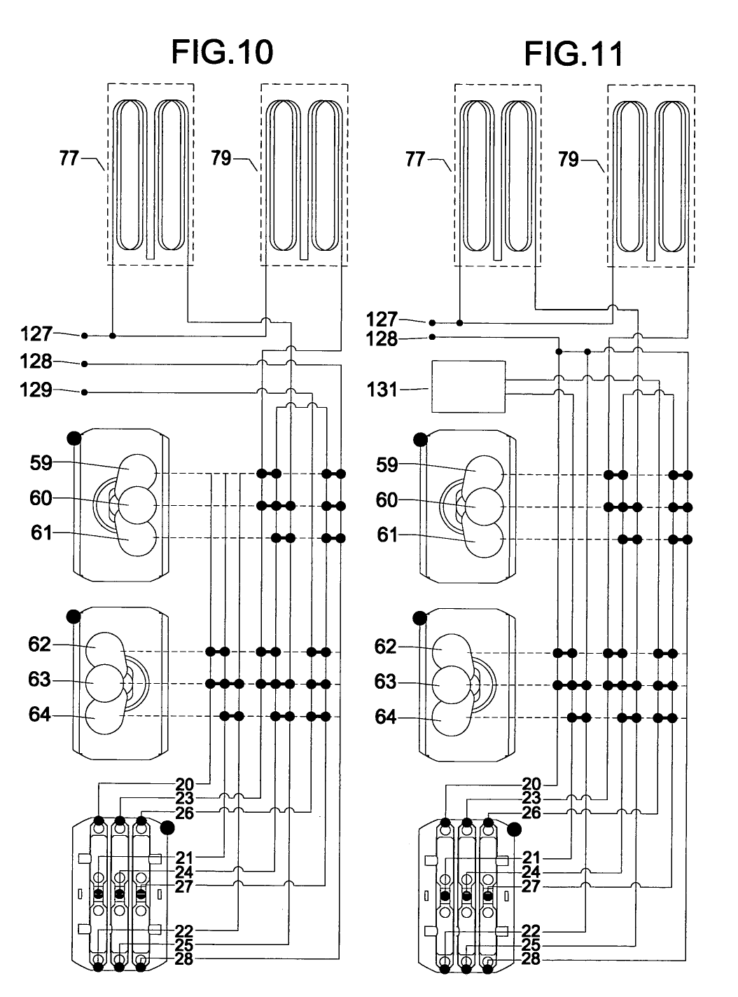

FIG. 10 illustrates how the outputs of pickups 77 and 79 are selectively connected to output pairing 127+128 in positions 59 through 61 via the connections 27+28. In positions 62 through 64, the same pickup selections are connected to output pairing 127+129 via the connections 26+27. When terminals 127+128+129 are connected, via a stereo jack socket and lead, to alternative amplification and/or processing equipment, this arrangement effectively provides integrated pickup and dual channel selection normally effected from discrete switching.

FIG. 11 illustrates how the outputs of pickups 77 and 79 are selectively connected to output pairing 127+128 via the connections 27+28 thus providing the customary pickup settings in positions 59 through 61. These settings are also exhibited in positions 62 through 64 at which additional circuit element 131 is introduced to the output path via the connections 26+27 and 20+21+22. Additional circuit element 131 may be a preamplifier, tone control or effects device such as are customarily used. This effectively provides integrated control of additional circuit elements normally effected from discrete switching.

In respect of embodiment ‘B’, FIG. 12 illustrates a stringed instrument of the electric guitar type wherein a plurality of strings 76 are anchored and tensioned in such a way that their vibration interacts with bridge pickup 77, middle pickup 78, and neck pickup 79 which are also mounted on the guitar. Mounted internally within the guitar but with outwardly protruding toggle member 29, the compound selector switch is positioned so as to be manually operable by the player.

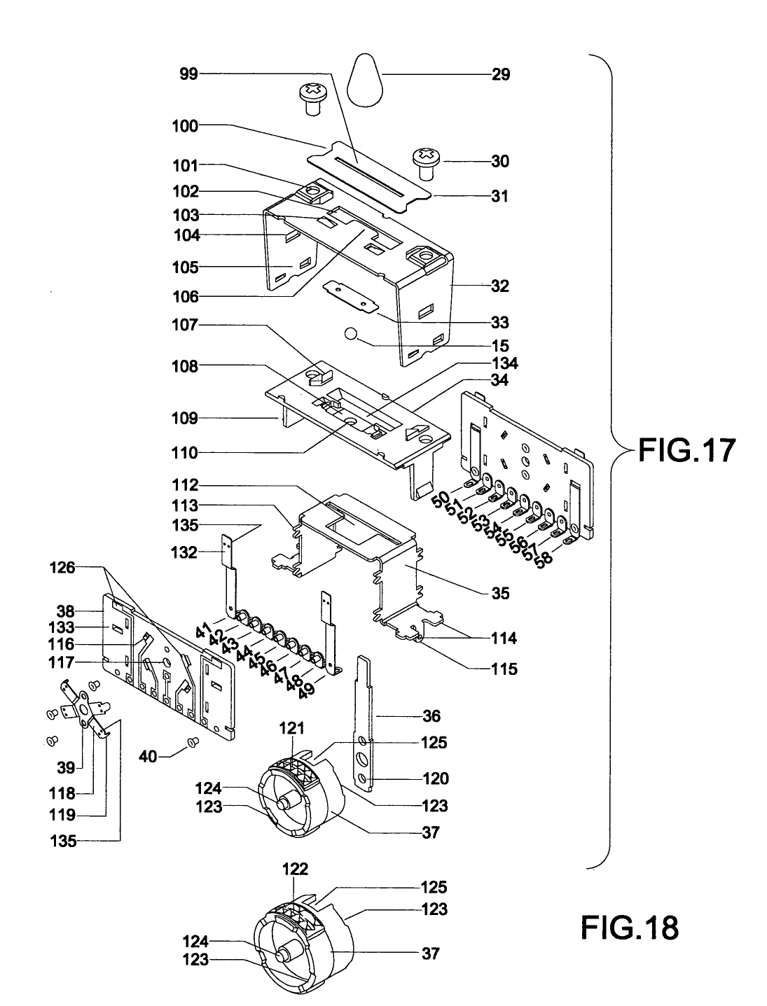

FIG. 13 through FIG. 15 show plan views of said outwardly protruding toggle member 29 arid illustrate examples of index positions available from this type of compound selector switch which will be described in the following paragraphs. FIG. 16 shows a view of the assembled embodiment ‘B’ compound selector switch, whereas FIG. 17 illustrates all of the component parts in exploded form.

With reference to FIG. 17 through FIG. 19, toggle member 29 is a plastic moulded cap which attaches by push-fit means to lever 36 which is a stamped steel component, adapted with holes 120 so that it may be attached, by means of heat peening, to rotary detent moulding 37 by location within rebate 125. Housing 32 is a pressed steel component to which top moulding 34 attaches by means of location of legs 109 into cut-outs 104. Flat spring 33, of a resilient steel material, locates into corresponding rebate area 108 of top moulding 34 such that when assembled it's ends engage on tabs 103. Top moulding 34 is adapted with hole 110 to receive steel ball 15 such that it then engages centrally on flat spring 33. Top moulding 34 is further adapted with aperture 134 to accept lever 36. Rotary detent moulding 37 and top moulding 34 are injection moulded in a suitably resilient material such as polypropylene.

Housing 32 is adapted with aperture 102 to accept lever 36. Aperture 102 limits the overall movement of lever 36 and may be adapted: with tongue 106 to enable the index progression shown in FIG. 13, or; without to enable the index progressions shown in FIG. 14 (thus adding position 72) and FIG. 15 (thus adding positions 71, 72 and 73).

Dependant upon the orientation of rotary detent moulding 37, steel ball 15 engages upon either detent pattern 121 (a five+five pattern, as shown in FIG. 17 and exhibited in FIG. 13 and FIG. 15), or detent pattern 122 (a five+three pattern, as shown in FIG. 18 and as exhibited in FIG. 14). Thus all three models illustrated in FIG. 13 through FIG. 15 can be achieved with minimal component diversity.

Mask 31 is a stamped flat plastic component adapted with central slot 99 which accepts lever 36 and is further adapted with end notches 100 which define transverse displacement by their engagement upon guide bosses 107 of top moulding 34. Housing 32 is adapted with raised mounting points 101 such that mask 31 can move freely in the assembled state. Raised mounting points 101 are adapted with threaded holes to accept fixing screws 30, thus enabling fixture to guitar body 75.

Printed circuit boards 38 are adapted with outer conductive tracks 126 which correspond to outer contacts 41, 49, 50 and 58, centre contacts 39, and solder terminals 42 through 48 and 51 through 57. Outer contacts 41, 49, 50 and 58 locate through slots 133 such that their inwardly biased ends 132 engage positively upon corresponding conductive tracks 126 by means of inwardly protruding contact points 135 and are secured in position by means of hollow rivets 40. Centre contacts 39 are attached to printed circuit boards 38 such that their inwardly biased ends 118 engage positively upon corresponding conductive tracks 126 by means of inwardly protruding contact points 135 and are secured by means of hollow rivets 40 thereby also creating common electrical connections terminated in solder terminals 45 and 54. Centre contacts 39 are further adapted with end flanges 119 which offer through slots 116 and engage selectively with side profiling 123 on rotary detent moulding 37. Centre and outer contacts are of a material customarily used in such applications such as Phosphor Bronze and may be treated with surface platings as may conductive tracks 126.

Solder terminals 42 through 48 and 51 through 57 have integral rivet form such that they form positive electrical contact with conductors 126 when pressed.

Printed circuit boards 38 are further adapted with central holes 117 which define an axial location for rotary detent moulding 37 by means of corresponding protrusions 124. Printed circuit boards 38 are further adapted with slots to accept claw-from 113 of pressed steel spacer 35. Claw-forms 113 secure both printed circuit boards 38 to spacer 35 thus capturing rotary detent moulding 37. Spacer 35 is further adapted with aperture 112 to accept lever 36 and rotary detent moulding 37.

Spacer 35 is further adapted with tabs 115 which serve as ground terminations for subsequent wiring and also with tabs 114 which offer into corresponding slots 105 of housing 32 so as to define a transverse freedom of pivotal movement.

FIG. 20 demonstrates the relationship between centre contact 39 and rotary detent moulding 37 where the electrical contact between the inwardly biased ends 118 and corresponding conductive tracks 126 is selectively broken by means of engagement between end flanges 119 and the side profiling 123 of rotary detent moulding 37.

FIG. 21 and FIG. 22 demonstrate the effect of transverse displacement of lever 36 where steel ball 15 engages upon parallel impressions of detent patterns 121 or 122 by means of pressure from flat spring 33 and where outer contacts 41 and 50 either engage upon the corresponding conductive tracks of printed circuit board 38 or are displaced by their engagement upon corresponding surface 111 of top moulding 34.

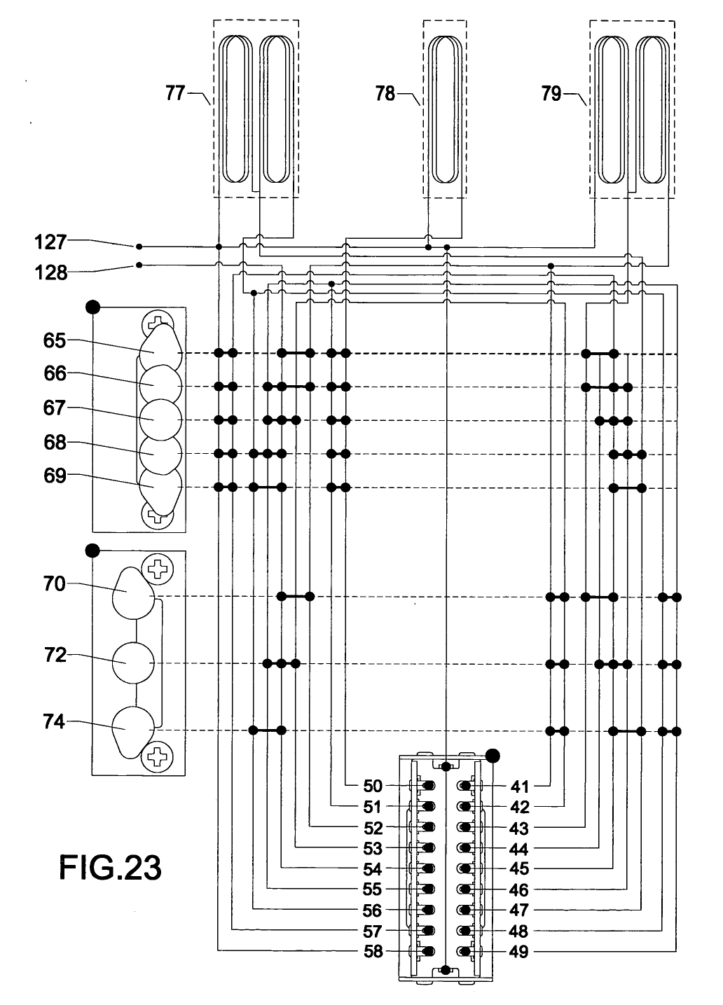

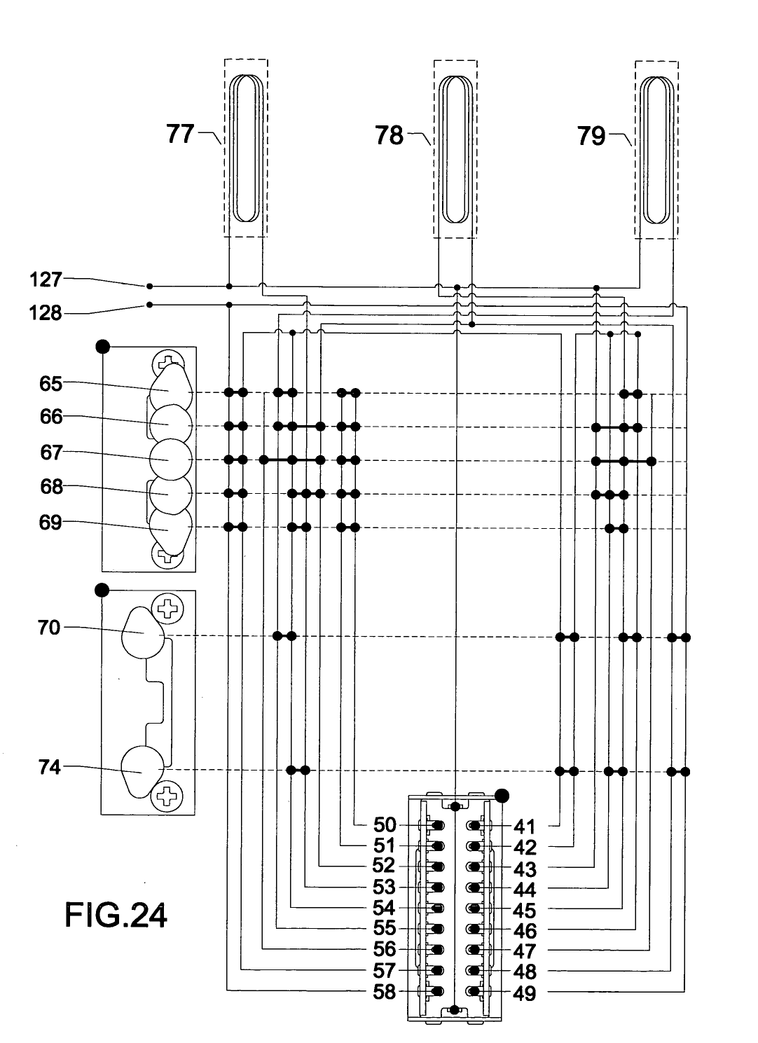

FIG. 23 and FIG. 24 illustrate the preferred electrical function, relative to each index position, of the embodiment ‘B’ compound selector switch in two separate examples. It should be understood that embodiment ‘B’ can also perform all of the applications relating to embodiment ‘A’ but in three pickup format, such applications typically being performed by the FIG. 15 model.

FIG. 23 illustrates the index progression of FIG. 14 which is achieved by freeing the travel of lever 36 by omitting tongue 106 to housing 32 and inverting rotary detent moulding 37 as shown in FIG. 18. The outputs of pickups 77, 78 and 79 are selectively connected to output pairing 127+128 in positions 65 through 69 at which settings the centre taps of pickups 77 and 79 are connected to ground at 127 by connections at 45+47 and 45+43 which effectively produces the five customary single-coil settings. In the transversely displaced state, the outputs of pickups 77 and 79 are further connected to 55 and 53 via connections at 48+49 and 41+42 respectively, middle pickup 78 is disconnected by 50+51 and the ground connection to the centre taps is disconnected by 57+58 which effectively produces the three customary dual-coil settings in positions 70, 72 and 74. This application provides guitarists with a truly comprehensive means of selecting the eight well known settings from a single switch element which appears to operate as a consistent integration of the familiar five-position switch with the familiar three-position switch.

FIG. 24 illustrates the index progression of FIG. 13 which is achieved by restricting the travel of lever 36 by including tongue 106 in housing 32. The outputs of pickups 77, 78 and 79 are selectively connected, via 57+58, to output pairing 127+128 which effectively produces the five customary single-coil settings in positions 65 through 69. Note that in these five settings, one of middle pickup 78's conductor's is connected to ground via 45+44+46+43, whereas it's other conductor selectively connects, via 52+54+57+58 to output 128. In the transversely displaced state, one of middle pickup 78's conductors is connected directly to output 128 via connections 48+49, whereas the other conductor is connected via 44+45+46+42+41 to: bridge pickup 77, via 53+54, in position 74, and; neck pickup 79, via 54+55, in position 70. This effectively produces: bridge pickup 77 in series with middle pickup 78 in position 74, and; neck pickup 79 in series with middle pickup 78 in position 70. This application provides guitarists with the conventional means of selecting the five familiar single-coil sounds but of also simulating the two familiar dual-coil sounds from a single switch element fitted to a three single-coil pickup guitar and represents a significant addition to the tonal spectrum of a guitar of this type.

It can be seen from the foregoing examples that the compound selector switch offers significant practical advantages in its capability of pickup configuration and concurrent control of associated switching functions.

Unlike the progressive examples cited in the prior art, the compound selector switch requires the use of only one switch element, where index positions perform only one known function, where all settings are immediately recognisable, where the progression through index positions is familiar, where superfluous settings are avoided, and where negligible impact is made upon installation.

Because the compound selector switch is, to a large extent, only an integrated version of the switch elements already in use on many guitars it does not, of itself, represent a considerable cost premium. It is even foreseeable that manufacturers could derive assembly savings from fitting a single switch element in place of two or more.

The foregoing disclosure has been set forth merely to illustrate the invention and is not intended to be limiting in either application or embodiment. For example, the invention as manifested in embodiment ‘A’ or ‘B’ could be produced in a totally different construction, but providing an equivalent operation, or, the transverse motion could be further adapted to include more than two levels of parallel displacement, or, the longitudinal indexing progression could be adapted to provide two, four or six positions. Additional modifications, or variations, which occur to those skilled in the art may differ from those disclosed herein without departing from the spirit or scope of the inventive concept as defined by the appended claims and their equivalence.

1. An electrical switch apparatus, for use on stringed musical instruments such as various types of electric guitar, wherein a single manually-operable actuator element travels substantially longitudinally between index positions so as to selectively connect pickup(s) for resultant amplification but where additional electrical switching function is performed by means of the substantially transverse displacement of said actuator element.

2. An electrical switch apparatus as in claim 1 where the substantially transverse displacement makes available substantially parallel groups of index positions where said groups exhibit an equivalent indexing progression.

3. An electrical switch apparatus as in claim 1 where the substantially transverse displacement makes available substantially parallel groups of index positions where groups exhibit differing indexing progressions as the result of alternative detent patterns being introduced during the transverse travel.

4. An electrical switch apparatus as in claim 1 where the substantially transverse displacement makes available one or more specific index position(s) adjacent to the substantially longitudinal travel.

5. An electric guitar switching circuit comprising a pickup selector switch which exhibits substantially longitudinal and transverse motions whereby said transverse motion has the resultant electrical effect of selectively:
disabling one of the coils of dual-coil pickup(s);
reversing the phase relationship between pickups;
configuring pickups, or pickup coils, to be relatively in series or in parallel;
introducing further pickup(s) or sound source(s) into an output path;
controlling the status of additional onboard circuitry;
assigning one of a number of independent output paths;
controlling the status of remote processing or amplification equipment, or;
muting the output.

6. An electrical switch apparatus and applications thereof as defined and described in the drawings and specification herein.
